(19) United States
(12) Patent Application Publication
(10) Pub. No.: US 2023/0044965 A1
(43) Pub. Date: Feb. 9, 2023

(54) CRUISE CONTROL METHOD FOR VEHICLE

(71) Applicants: HYUNDAI MOTOR COMPANY, Seoul (KR); KIA CORPORATION, Seoul (KR)

(72) Inventor: Jin Young Whang, Suwon-si (KR)

(73) Assignees: Hyundai Motor Company, Seoul (KR); Kia Corporation, Seoul (KR)

(21) Appl. No.: 17/832,023

(22) Filed: Jun. 3, 2022

(30) Foreign Application Priority Data
Jul. 20, 2021 (KR) 10-2021-0094552

(51) Int. Cl. B60W 30/14; B60W 40/076; B60W 40/105

(52) U.S. Cl. CPC B60W 30/143; B60W 40/076; B60W 40/105; B60W 2400/00; B60W 2530/13; B60W 2530/209; B60W 2552/15

(57) ABSTRACT

A cruise control method for a vehicle includes: calculating maximum and minimum vehicle speeds based on a reference vehicle speed in a driving mode of deceleration after acceleration; setting a range of an upper and lower limit vehicle speeds for acceleration and deceleration driving by adding and subtracting a preset incremental value to and from the reference vehicle speed within the maximum and minimum vehicle speeds; calculating fuel efficiency by calculating fuel quantity and mileage according to a preset acceleration condition and by calculating fuel quantity and mileage according to fuel cut control and neutral control in a deceleration condition within the range of the upper and lower limit vehicle speeds; repeating the fuel efficiency calculation when the incremental value is additionally added to and subtracted from the range; and determining a set of driving conditions through repeating the calculating fuel efficiency.

### CROSS REFERENCE TO RELATED APPLICATION

The present application claims the benefit of priority to Korean Patent Application No. 10-2021-0094552, filed on Jul. 20, 2021 in the Korean Intellectual Property Office, the entire contents of which is incorporated herein for all purposes by reference.

### TECHNICAL FIELD

The present disclosure relates generally to a cruise control method for a vehicle and, more particularly, to a cruise control method for a vehicle that can improve fuel efficiency of the vehicle by allowing driving control to be performed along optimal acceleration and deceleration sections based on vehicle speed profile information, gradient information, and the like.

### BACKGROUND

In general, an auto cruise control device for a vehicle is a device configured to automatically drive a vehicle at a set vehicle speed without manipulation of an accelerator pedal by a driver and is also referred to as a constant speed driving device.

When a target vehicle speed is set by the driver's simple manipulation, such an auto cruise control device controls the vehicle speed to the target vehicle speed set by the driver, thereby greatly reducing the driver's operation of the accelerator pedal and improving driving convenience.

In general, in an auto cruise control device, when a required torque (cruise torque) for maintaining a target vehicle speed is determined, in the case of an internal combustion engine (engine) vehicle such as a gasoline or diesel vehicle, engine driving is controlled to allow the output of the requested torque to be achieved through cooperative control between controllers, and through this, the auto cruise driving maintaining the target vehicle speed is performed.

In addition, in the case of an electric vehicle driving using a motor, the motor torque is controlled according to the torque required to maintain a target vehicle speed, and in the case of a hybrid vehicle driving using a motor and an engine, power is distributed to the motor and the engine to output the required torque.

In addition, during constant-speed cruise driving in a general internal combustion engine vehicle, an operating point of an engine is determined by the vehicle speed and a transmission shift step and is determined irrespective of the Engine Optimal Operating Line (hereinafter referred to as “OOL”).

Accordingly, constant speed auto cruise driving of an internal combustion engine vehicle has an unfavorable aspect in terms of fuel efficiency, and cruise control technology capable of improving fuel efficiency has been proposed.

For example, utility of the Pulse and Glide (hereinafter referred to as “PnG”) driving pattern, which improves fuel efficiency on the road while repeating acceleration and deceleration of the vehicle at regular intervals during cruise driving, has been proven in various ways.

That is, PnG driving refers to a driving pattern that, while maintaining the average target vehicle speed, allows a vehicle to be operated in the Pulse phase and the Glide phase, wherein, in the Pulse phase, a vehicle is operated at a point with good engine efficiency by moving the engine operating point close to COL while increasing the vehicle speed and, in the Glide phase, the vehicle is operated by performing coasting, thereby being capable of reducing the overall amount of fuel consumed compared to the existing constant speed driving. Accordingly, in the Pulse phase, the vehicle is accelerated up to a speed higher than the cruise vehicle speed set by the driver, and in the Glide phase, the vehicle is decelerated by coasting driving in an engine fuel cut state.

In the case of the PnG driving, as described above, the vehicle is driven by allowing the Pulse phase and the Glide phase to be periodically alternated and repeated. The variable amount of vehicle speed (related to drivability) and the amount of fuel savings are in a trade-off relationship, so an optimal control technology capable of simultaneously satisfying drivability and fuel efficiency improvement is required.

The foregoing is intended merely to aid in the understanding of the background of the present disclosure and is not intended to mean that the present disclosure falls within the purview of the related art that is already known to those skilled in the art.

### SUMMARY

Accordingly, the present disclosure has been made keeping in mind the above problems occurring in the related art, and the present disclosure is intended to propose a cruise control method for a vehicle, wherein, when a driving mode of deceleration after acceleration is selected of a cruise control mode, acceleration driving and a deceleration driving are repeated within a range of an upper limit vehicle speed and a lower limit vehicle speed calculated based on a reference vehicle speed input from a driver, wherein fuel economy is repeatedly calculated by calculating fuel quantity and mileage for each preset acceleration according to road gradient information during the acceleration driving, the fuel economy is repeatedly calculated by calculating the fuel quantity and mileage for each of fuel cut control and neutral control during the deceleration driving, and by deriving respective optimal fuel efficiency for each of the road gradient information, driving is performed in a combination of acceleration driving conditions different from one another and decelerating driving conditions corresponding to the optimal fuel efficiency according to gradient of a road where the vehicle is currently being driven, thereby improving the fuel efficiency of the vehicle.

In order to achieve the above objective, a cruise control method for a vehicle according to the present disclosure may include steps of: calculating maximum and minimum vehicle speeds based on a reference vehicle speed input from a driver when a driving mode of deceleration after acceleration is selected; setting a range from an upper limit vehicle speed to a lower limit vehicle speed for acceleration and deceleration driving by adding and subtracting a preset incremental value to and from the reference vehicle speed within the maximum vehicle speed and the minimum vehicle speed; calculating fuel efficiency by calculating fuel quantity and mileage according to a preset acceleration condition and by calculating fuel quantity and mileage according to each of a fuel cut control and a neutral control in a preset deceleration condition within the range from the upper limit vehicle speed to the lower limit vehicle speed; repeating the step of calculating fuel efficiency in a state in which the incremental value is additionally added to and subtracted from the range from the upper limit vehicle speed to the lower limit vehicle speed; and determining a set of driving conditions of allowing driving to be performed by selecting the range of the upper limit vehicle speed and the lower limit vehicle speed in which the fuel efficiency is maximum and selecting a combination of the preset acceleration condition and the preset deceleration condition in the corresponding range, through the repeatedly performing the step of calculating fuel efficiency.

When the range of the upper limit vehicle speed and the lower limit vehicle speed coincides with the range of the maximum vehicle speed and the minimum vehicle speed due to the incremental value additionally added to or subtracted from the range continuously, the repeatedly performing the step of calculating fuel efficiency may stop repetition of the step of calculating fuel efficiency.

In addition, the selecting a driving method selectively may store the preset acceleration condition and the preset deceleration condition at the upper limit vehicle speed and the lower limit vehicle speed at which the fuel efficiency may be maximum as the repeatedly performing the calculating fuel efficiency may be stopped.

In addition, the calculating fuel efficiency may include calculating the fuel quantity and mileage according to the preset acceleration condition according to road gradient information by receiving the road gradient information through a controller in real time and the fuel quantity and mileage according to each of the fuel cut control and the neutral control in the preset deceleration condition.

Here, as a plurality of road gradient information different from one another may be input, the controller may control such that the step of setting a range of an upper limit vehicle speed and a lower limit vehicle speed, the step of calculating fuel efficiency, and the repeatedly performing the step of calculating fuel efficiency are repeatedly performed.

On the other hand, based on a fuel consumption rate map of an engine and a transmission efficiency map of a transmission transmitted from the engine and the transmission, respectively, the step of calculating fuel efficiency may include calculating the fuel quantity and mileage for each acceleration included in the preset acceleration condition through the controller and the fuel quantity and mileage for each of the fuel cut control and the neutral control according to the corresponding acceleration, thereby calculating the fuel efficiency for each combination of a plurality of acceleration conditions and deceleration conditions.

In addition, the step of calculating a vehicle speed may include calculating the maximum vehicle speed and the minimum vehicle speed by adding and subtracting a difference value input by the driver with respect to the reference vehicle speed.

As described above, according to the present disclosure, when a driving mode of deceleration after acceleration is selected of a cruise control mode, acceleration driving and a deceleration driving are repeated within a range of an upper limit vehicle speed and a lower limit vehicle speed calculated based on a reference vehicle speed input from a driver, wherein fuel economy is repeatedly calculated by calculating fuel quantity and mileage for each preset acceleration according to road gradient information during the acceleration driving, the fuel economy is repeatedly calculated by calculating the fuel quantity and mileage for each of fuel cut control and neutral control during the deceleration driving, and by deriving respective optimal fuel efficiency for each of the road gradient information, driving is performed in a combination of acceleration driving conditions different from one another and decelerating driving conditions corresponding to the optimal fuel efficiency according to gradient of a road where the vehicle is currently being driven, thereby having an effect of improving the fuel efficiency of the vehicle.

### BRIEF DESCRIPTION OF THE DRAWINGS

The above and other objectives, features, and other advantages of the present disclosure will be more clearly understood from the following detailed description when taken in conjunction with the accompanying drawings, in which:

FIG. 1 is a diagram sequentially illustrating a cruise control method of a vehicle according to an exemplary embodiment of the present disclosure;

FIG. 2 is a diagram illustrating a range of a maximum vehicle speed and a minimum vehicle speed calculated with respect to the cruise control method of a vehicle according to an exemplary embodiment of the present disclosure;

FIG. 3 is a diagram illustrating a range of an upper limit vehicle speed and a lower limit vehicle speed calculated with respect to the cruise control method of a vehicle according to an exemplary embodiment of the present disclosure;

FIG. 4 is a diagram illustrating acceleration conditions and deceleration conditions with respect to the cruise control method of a vehicle according to an exemplary embodiment of the present disclosure;

FIG. 5 is a diagram illustrating acceleration conditions and deceleration conditions in which an incremental value is added or subtracted with respect to the cruise control method of a vehicle according to an exemplary embodiment of the present disclosure;

FIG. 6 is a diagram illustrating an example of engine operating lines according to acceleration conditions with respect to the cruise control method of a vehicle according to an exemplary embodiment of the present disclosure; and

FIG. 7 is a diagram illustrating a configuration for calculating mileage and fuel quantity with respect to the cruise control method of a vehicle according to an exemplary embodiment of the present disclosure.

### DETAILED DESCRIPTION

Hereinbelow, exemplary embodiments of the present disclosure will be described in detail with reference to the accompanying drawings.

Advantages and features of the present disclosure, and a method of achieving same will become clear with reference to the embodiments described below in detail in conjunction with the accompanying drawings.

However, the present disclosure is not limited by the embodiments disclosed below but will be embodied in various forms different from one another. In addition, the present embodiments are only provided to allow the disclosure of the present disclosure to be complete and to fully inform those of ordinary skill in the art to which the present disclosure pertains a scope of the present disclosure. Accordingly, the present disclosure is only defined by the scope of the claims.

In addition, in the description of the present disclosure, when it is determined that related known technologies and the like may obfuscate the gist of the present disclosure, a detailed description thereof will be omitted.

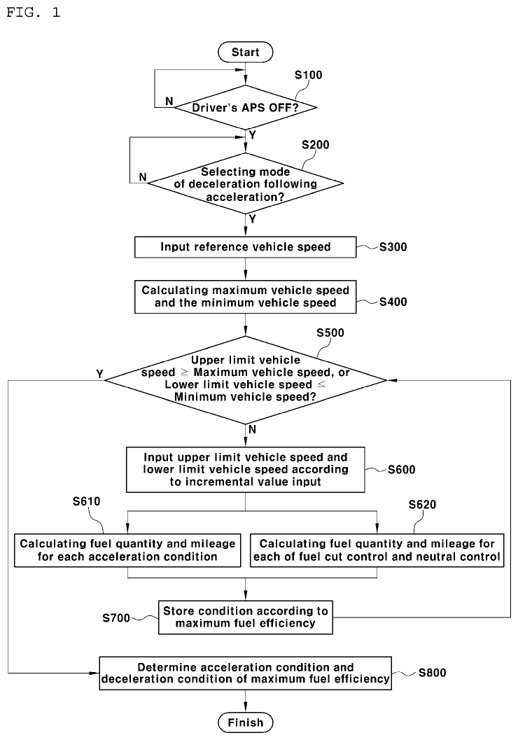

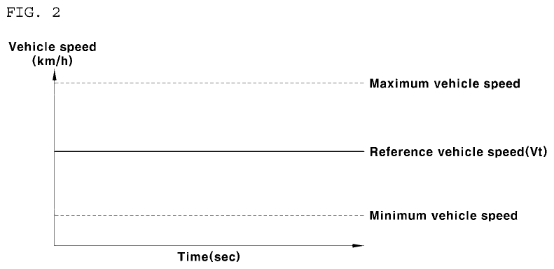

FIG. 1 is a diagram sequentially illustrating a cruise control method of a vehicle according to an exemplary embodiment of the present disclosure, and FIG. 2 is a diagram illustrating a range of a maximum vehicle speed and a minimum vehicle speed calculated with respect to the cruise control method of a vehicle according to an exemplary embodiment of the present disclosure.

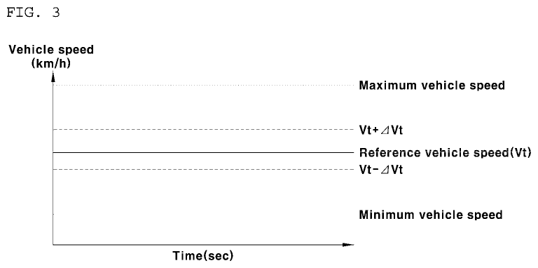

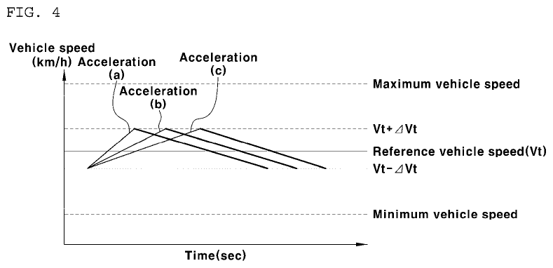

In addition, FIG. 3 is a diagram illustrating a range of an upper limit vehicle speed and a lower limit vehicle speed calculated with respect to the cruise control method of a vehicle according to an exemplary embodiment of the present disclosure, and FIG. 4 is a diagram illustrating acceleration conditions and deceleration conditions with respect to the cruise control method of a vehicle according to an exemplary embodiment of the present disclosure.

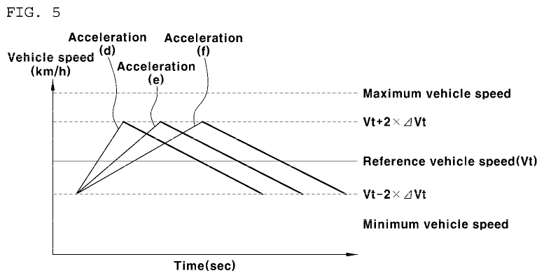

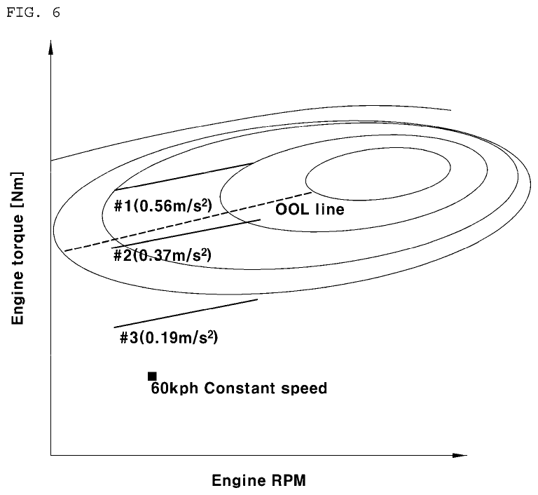

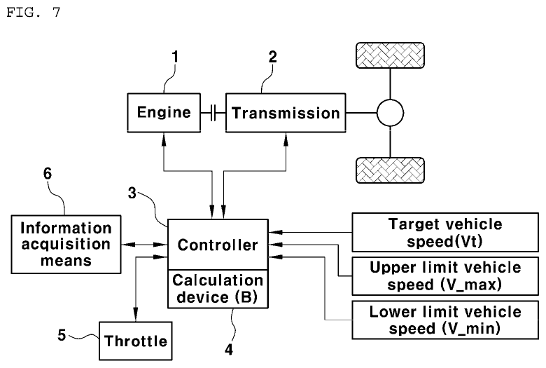

In addition, FIG. 5 is a diagram illustrating acceleration conditions and deceleration conditions in which an incremental value is added or subtracted with respect to the cruise control method of a vehicle according to an exemplary embodiment of the present disclosure, FIG. 6 is a diagram illustrating an example of engine operating lines according to acceleration conditions with respect to the cruise control method of a vehicle according to an exemplary embodiment of the present disclosure, and FIG. 7 is a diagram illustrating a configuration for calculating mileage and fuel quantity with respect to the cruise control method of a vehicle according to an exemplary embodiment of the present disclosure.

In general, during constant speed cruise driving in an internal combustion engine vehicle, an engine operating point is determined by a vehicle speed and a transmission shift step and is operated at an optimal operating line (OOL) by an engine's power optimization strategy.

That is, when the vehicle is driven at a constant speed cruise, the engine is driven by determining an operating point so as to follow the OOL that may produce the optimal efficiency. In other words, the vehicle is driven at a preset acceleration in an acceleration section, thereby being driven at a point where the engine fuel efficiency is optimal. In the case of coasting performed in a deceleration section, the method, selecting and fixing either one of a fuel cut condition or a neutral control condition, is used. As a result, it has the effect of improving fuel efficiency compared to a case when driving at a constant speed, but it may not be regarded as an optimal driving method.

TABLE 1

| | Acceleration | | | Deceleration | | Overall |
|---|---|---|---|---|---|---|
| | | Fuel | Fuel | | Fuel | fuel |
| | Mileage | quantity | efficiency | Mileage | quantity | efficiency |
| Item | m | kg | km/l | m | kg | km/l |
| #1 | 178 | 0.0161 | 8.25 | 314 | 0 | 22.77 |
| #2 | 267 | 0.0228 | 11.75 | 314 | 0 | 25.54 |
| #3 | 532 | 0.0317 | 16.79 | 314 | 0 | 26.69 |

For example, when viewed with reference to [Table 1] and FIG. 6 above, when deceleration driving is performed using the fuel cut control, the overall fuel efficiency is calculated for a result of the fuel efficiency test according to acceleration conditions (#1, #2, and #3) different from one another through a preset relationship when a deceleration distance is short, wherein the relationship is represented as “Fuel efficiency [km/l]=(mileage during acceleration+mileage during deceleration)/(fuel quantity during acceleration+fuel quantity during deceleration).” In this case, the fuel efficiency is the most dominant in #3, which is gently accelerated compared to #2, which is close to the OOL. Accordingly, as driving following the engine CCL line is #2, driving following the engine CCL line is not always the optimal fuel economy.

In the end, the overall fuel efficiency of the vehicle is determined by the relationship between the mileage and the fuel quantity during acceleration and deceleration, and the cruise control method of a vehicle according to the present embodiment, the method using such a relationship above, will be sequentially described with reference to FIG. 1 as follows.

First, in a state in which an accelerator position sensor (APS) is turned OFF in S100, an operation of cruise control is performed, but whether or not a driving mode of deceleration after acceleration is to be selected is determined in S200, wherein the driving mode of deceleration after acceleration repeats acceleration and deceleration within a predetermined range rather than drives while maintaining a constant acceleration.

Here, when the driving mode of deceleration after acceleration is selected by a driver's manipulation in S200, a reference vehicle speed is input from the driver in S300.

As described above, based on the input reference vehicle speed, the maximum vehicle speed and the minimum vehicle speed for setting a range in which the acceleration driving and the deceleration driving are to be repeated are calculated in S400.

That is, for example, when the reference vehicle speed input from the driver is 60 kph, and a difference between the vehicle speed set by the driver's manipulation is 20 kph, the maximum vehicle speed and the minimum vehicle speed may be calculated as 70 kph and 50 khp, respectively, as shown in FIG. 2, by preset calculation formulae for calculating the maximum vehicle speed and the minimum vehicle speed, wherein, the formulae are represented more specifically as “Maximum vehicle speed (V_max)=Reference vehicle speed (vt)+Vehicle speed difference (Δx)/2”, and “Minimum vehicle speed (V_min)=Reference vehicle speed (vt)—Vehicle speed difference (Δx)/2”.

Thereafter, the range of the upper limit vehicle speed and the lower limit vehicle speed for acceleration driving and deceleration driving within the maximum vehicle speed and the minimum vehicle speed is set by adding or subtracting a preset incremental value Δvt to the reference vehicle speed vt. That is, the range (vt+Δvt to vt−Δvt) for allowing the deceleration driving after the acceleration driving to be performed is set as shown in FIG. 3. Subsequently, it is determined whether such a range of the upper limit vehicle speed and the lower limit vehicle speed exceeds the maximum vehicle speed and the minimum vehicle speed, such as 70 kph and 50 khp, as above, in S500.

In this case, as described above, when it is assumed in S600 that the reference vehicle speed is 60 kph and that the incremental value is input as preset 2 kph, the upper limit vehicle speed is a value obtained by adding the incremental value to the reference vehicle speed, and the lower limit vehicle speed is a value obtained by subtracting the incremental value from the reference vehicle speed, so the upper limit vehicle speed and the lower limit vehicle speed may each be set to 62 kph and 58 kph, for example.

Here, although it has been described that the incremental value is set to 2 kph in order to subdivide the fuel efficiency calculation during acceleration driving and deceleration driving according to accelerations different from one another, in order to simplify the calculation of fuel efficiency calculation, a value no less than 2 kph within the range of the upper limit vehicle speed and the lower limit vehicle speed may even be set

In a state set as described above, as shown in FIG. 4, as acceleration conditions different from one another, that is, information on acceleration, are input, the fuel quantity and the mileage according to the acceleration conditions are calculated within the range of the upper vehicle speed limit and the lower vehicle speed limit in S610, and in the deceleration condition, the fuel quantity and the mileage according to the fuel cut control and the neutral control are calculated, respectively, whereby the fuel efficiency is calculated accordingly in S620.

In other words, as shown in FIG. 7, a configuration of a system configured to calculate the mileage and fuel quantity for the cruise control method of a vehicle according to the present embodiment is provided with an engine 1 and a transmission 2 and is provided with an automatic driving device including a controller 3 configured to automatically control a throttle 5. In addition, the system is provided with: the information acquisition means 6 configured to acquire road gradient information and traffic information of a road ahead where the vehicle is being driven; a first map set with a fuel consumption rate based on the number of revolutions and the torque of the engine 1; and a second map set with the transmission efficiency of the transmission 2. As a result, the system is configured to calculate the fuel consumption of the engine 1 and the mileage of the vehicle through the calculation device 4 based on the first map and the second map when the vehicle speed profile and road gradient information of the vehicle are input.

Accordingly, when the upper limit vehicle speed, the lower limit vehicle speed, and the reference vehicle speed are input to the controller 3 using such a calculation device 4 when accelerations different from one another are input, the controller 3 calculates the fuel quantity and mileage for each acceleration differently input according to the road gradient information and traffic information of the road where the vehicle is being driven using the information received from the information acquisition means 6. in S610 and calculates fuel efficiency accordingly.

In addition, when each vehicle speed for each of the accelerations different from one another reaches a value obtained by adding the reference vehicle speed (vt) and the incremental value (Δvt) (refer to FIG. 4), the deceleration is carried out toward a value obtained by subtracting the incremental value (Δvt) from the reference vehicle speed (vt). During such deceleration, the fuel quantity and mileage for each of the fuel cut control and the neutral control are calculated, for example, as shown in [Table 2] below (S620), using the calculation device 4, thereby calculating the overall fuel efficiency.

TABLE 2

| Acceleration | Deceleration | Fuel quantity | Mileage | Fuel Efficiency |
|---|---|---|---|---|
| condition | condition | (kg) | (m) | (km/l) |
| Acceleration | Fuel Cut | 0 | 304 | 25.0 |
| (a) | Neutral | 0.0048 | 604 | 26.3 |
| | control | | | |
| Acceleration | Fuel Cut | 0 | 304 | 24.3 |
| (b) | Neutral | 0.0048 | 604 | 27.5 |
| | control | | | |
| Acceleration | Fuel Cut | 0 | 304 | 24.5 |
| (c) | Neutral | 0.0048 | 604 | 23 |
| | control | | | |

As shown in [Table 2], when the fuel efficiency is calculated to be maximum in the acceleration condition of the acceleration (b) among the three acceleration conditions and the neutral control of the deceleration conditions of the fuel cut control and the neutral control, the acceleration conditions and deceleration conditions at the upper limit vehicle speed and the lower limit vehicle speed according to the maximum fuel efficiency are selectively stored in S700.

As described above, when storing the acceleration condition and the deceleration condition in S700 is completed, as shown in FIG. 5, an additionally increased incremental value (2*Δvt) is again added to or subtracted from the reference vehicle speed vt, whereby fuel quantity and mileage for each of accelerations different from one another are calculated. In addition, fuel efficiency is repeatedly calculated and stored accordingly.

That is, based on the same road gradient information and traffic information as before, the fuel efficiency according to each acceleration condition and deceleration condition is re-calculated as in [Table 2] above for a plurality of acceleration conditions (for example, acceleration (d), acceleration (e), and acceleration (f)), refer to FIG. 5, whereby the acceleration condition and the deceleration condition with the maximum fuel efficiency among the number of the fuel efficiency obtained above are repeatedly stored, wherein the plurality of acceleration conditions is increased additionally other than the previous acceleration conditions by allowing additionally increased incremental value to be added to or subtracted from the reference vehicle speed.

In this case, in additionally adding or subtracting the incremental value, when the value coincides with or may exceed the range of the maximum vehicle speed and the minimum vehicle speed range, the calculation of fuel efficiency according to the acceleration condition and the deceleration condition is stopped, and the driving may be performed on the corresponding road gradient information and traffic information according to the acceleration conditions and deceleration conditions corresponding to the maximum fuel efficiency among the accumulated fuel economy in S800.

For example, as in S400 described above, in a state, where the maximum vehicle speed and the minimum vehicle speed are respectively 70 kph and 50 kph, the reference vehicle speed vt is 60 kph, and the incremental value Δvt is 2 kph, when the additional incremental value corresponds to 5*Δvt, the values obtained by adding and subtracting the additional incremental value (5*Δvt) to and from the reference vehicle speed (vt), respectively, coincide with the maximum vehicle speed and the minimum vehicle speed, respectively, so that driving may be performed in the corresponding road gradient information and traffic information, according to the acceleration conditions (acceleration) and deceleration conditions corresponding to the maximum fuel efficiency among the fuel efficiency accumulated and stored up to a point in time of coincidence of the values obtained above with the maximum vehicle speed and the minimum vehicle speed.

As a result, in the present embodiment, when different road gradient information and traffic information are input to the controller 3 in real time, the above-described S300 to S800 are sequentially performed through the calculation device 4 of the controller 3, respectively, so that the driving method may be determined based on combination of the acceleration and deceleration conditions corresponding to the optimal fuel efficiency calculated based on the corresponding road gradient information and traffic information. Therefore, the fuel efficiency of the vehicle may be effectively improved when the cruise control is controlled.

Accordingly, in the present embodiment, during cruise control of the vehicle, the vehicle is driven at a preset acceleration in an acceleration section, thereby being driven at a point where the fuel efficiency is the maximum, and during coasting performed in a deceleration section, it is possible to derive the effect of effective fuel efficiency improvement compared to a conventional cruise control method that uses a method of selecting and fixing any one of the fuel cut control and the neutral control.

According to the present disclosure, when the driving mode of deceleration after acceleration is selected of the cruise control mode, the acceleration driving and deceleration driving are repeated within the range of an upper limit vehicle speed and a lower limit vehicle speed calculated based on the reference vehicle speed input from the driver, wherein the fuel economy is repeatedly calculated by calculating the fuel quantity and mileage for each preset acceleration according to the road gradient information during the acceleration driving, the fuel economy is repeatedly calculated by calculating the fuel quantity and mileage for each of the fuel cut control and the neutral control during the deceleration driving, and by deriving the respective optimal fuel efficiency for each of the road gradient information, driving is performed in a combination of the acceleration driving conditions different from one another and decelerating driving conditions corresponding to the optimal fuel efficiency according to the gradient of the road where the vehicle is currently being driven, thereby having an effect of improving the fuel efficiency of the vehicle.

Although the present disclosure has been described with reference to the embodiment(s) shown in the drawings, this is only exemplary, and those skilled in the art will understand that various modifications may be made therefrom, and all or part of the above-described embodiment(s) configured by being optionally combined. Accordingly, the true technical protection scope of the present disclosure should be defined by the technical spirit of the appended claims.

What is claimed is:

1. A cruise control method for a vehicle, the method comprising steps of:
calculating maximum and minimum vehicle speeds based on a reference vehicle speed input from a driver when a driving mode of deceleration after acceleration is selected;
setting a range from an upper limit vehicle speed to a lower limit vehicle speed for acceleration and deceleration driving by adding and subtracting a preset incremental value to and from the reference vehicle speed within the maximum vehicle speed and the minimum vehicle speed;
calculating fuel efficiency by calculating fuel quantity and mileage according to a preset acceleration condition and by calculating fuel quantity and mileage according to each of a fuel cut control and a neutral control in a preset deceleration condition within the range from the upper limit vehicle speed to the lower limit vehicle speed;
repeating the step of calculating fuel efficiency in a state in which the incremental value is additionally added to and subtracted from the range from the upper limit vehicle speed to the lower limit vehicle speed; and
determining a set of driving conditions of allowing driving to be performed by selecting the range of the upper limit vehicle speed and the lower limit vehicle speed in which the fuel efficiency is maximum and selecting a combination of the preset acceleration condition and the preset deceleration condition in the selected range, through the repeatedly performing the step of calculating fuel efficiency.

2. The method of claim 1, wherein, when the range of the upper limit vehicle speed and the lower limit vehicle speed coincides with the range of the maximum vehicle speed and the minimum vehicle speed due to the incremental value additionally added to or subtracted from the range continuously, the repeatedly performing the step of calculating fuel efficiency stops repetition of the step of calculating fuel efficiency.

3. The method of claim 1, wherein the selecting a driving method selectively stores the preset acceleration condition and the preset deceleration condition at the upper limit vehicle speed and the lower limit vehicle speed at which the fuel efficiency is maximum as the repeatedly performing the calculating fuel efficiency is stopped.

4. The method of claim 1, wherein the step of calculating fuel efficiency includes calculating the fuel quantity and mileage according to the preset acceleration condition according to road gradient information by receiving the road gradient information through a controller in real time and the fuel quantity and mileage according to each of the fuel cut control and the neutral control in the preset deceleration condition.

5. The method of claim 4, wherein, as a plurality of road gradient information different from one another is input, the controller controls such that the step of setting a range of an upper limit vehicle speed and a lower limit vehicle speed, the step of calculating fuel efficiency, and the repeatedly performing the step of calculating fuel efficiency are repeatedly performed.

6. The method of claim 1, wherein, based on a fuel consumption rate map of an engine and a transmission efficiency map of a transmission transmitted from the engine and the transmission, respectively, the step of calculating fuel efficiency includes calculating the fuel quantity and mileage for each acceleration included in the preset acceleration condition through the controller and calculating the fuel quantity and mileage for each of the fuel cut control and the neutral control according to the corresponding acceleration, thereby calculating the fuel efficiency for each combination of a plurality of acceleration conditions and deceleration conditions.

7. The method of claim 1, wherein the step of calculating a vehicle speed includes calculating the maximum vehicle speed and the minimum vehicle speed by adding and subtracting a difference value input by the driver with respect to the reference vehicle speed.
